(19) United States
(12) Patent Application Publication
(10) Pub. No.: US 2007/0260628 A1
(43) Pub. Date: Nov. 8, 2007

(54) SYSTEM AND METHOD FOR PROVIDING A VIRTUAL DATABASE ENVIRONMENT AND GENERATING DIGITAL MAP INFORMATION

(75) Inventors: Gil Fuchs, Woodside, CA (US); Ettie Ettinger, Laguna Beach, CA (US); Eric Christopher Crowe, Concord, CA (US); Alan Dale Brown, Santa Clara, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 11/742,937

(22) Filed: May 1, 2007

Related U.S. Application Data
(60) Provisional application No. 60/797,130, filed on May 2, 2006.

(51) Int. Cl. G06F 7/00

(52) U.S. Cl. 707/101

(57) ABSTRACT

A system and method for providing a virtual map database, referred to herein as the “Virtual Database System” (VDB). The VDB allows integration of map data, often from various sources, in a consistent manner for supply to an end user, while simultaneously ensuring that the entity best able to support a particular data source retains control over the data. In accordance with an embodiment, the VDB environment enables third-party data providers to associate their third-party-files with a base map or file-of-reference, thereby allowing for the creation of dynamic relationships between digital map features and other third-party data providers. The integration may be performed in a dynamic or real-time fashion, receiving up-to-date information from the various sources, creating links, and composing virtual maps, as needed or on-demand. Since the information is linked between the map providers and the various third parties, whenever an item of information or a link between items is updated in either the file-of-reference or in one of the third-party files, that updated information can be propagated back to all of the third-parties for further use in their software applications.

### CLAIM OF PRIORITY

This application claims the benefit of U.S. Provisional Patent Application No. 60/797,130, filed on May 2, 2006, entitled “SYSTEM AND METHOD FOR PROVIDING A VIRTUAL DATABASE ENVIRONMENT AND GENERATING DIGITAL MAP INFORMATION”, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is related to systems for providing digital maps, and particularly to a system and method for providing digital map information using a virtual database technique.

### BACKGROUND

The use of digital geographic or map data has become commonplace in modern society. Commonly referred to as “electronic maps” or “digital maps”, the map data is already being used in a wide variety of applications. A typical application is within the travel industry, where digital maps are used to research travel destinations, resort facilities, and alternate routes. Internet-based business-to-consumer (B2C) companies often use digital maps to direct customers to theaters, stores, restaurants, and other commercial businesses. Digital maps are also often used in industrial settings, for example, to calculate routes for delivery drivers, or to provide directions for emergency and medical crews to follow when responding to emergency calls.

Increasingly, digital map providers have switched from a process of merely digitizing paper-based maps, and are now more appropriately seen as gatherers and organizers of an ever greater variety of data, covering topics such as street addresses, transportation networks, water bodies, parklands political districts, census data, demographic information, commercial businesses, and entertainment facilities, for the purpose of supporting the latest applications. At the same time, the variety of uses for this map data has also expanded to include such applications as in-car driving assistance; PDA and cell phone-based navigation; and locally-focused news, media, and yellow-page information services. With this increase in utility it has become evident that many of these software applications need to combine the underlying map data with other sources of location-related information to provide a more useful end-product.

Some companies have tried by themselves to make their single map database more content-rich. However, for a digital map company, it is neither efficient nor desirable to be in the business of continuously collecting and maintaining a universe of information regarding each and every place of interest, including the attributes for those places. Instead, a digital map company should ideally be allowed to focus on what it does best, i.e. create accurate digital maps. By focusing on this aspect of the map business, and intelligently integrating their digital map data with that of other organizations, all of the parties can increase the value of their data products, and the applications that use them.

A typical approach to map data integration is to create “overlay maps”, in which one digital map is used as a base map, and then additional information from another source (or sources) is overlaid atop that base map, to provide at least an illusion of a more complex map. This is the approach used in many Internet-based map information systems. For example, if a company wishes to provide an online restaurant-search utility, they can provide a first map A (which can be a typical map with streets, parks, and other such locations shown thereon). They can then overlay map A with a second map B that contains restaurant information and reviews. In response to a user request for a restaurant-map, the company can display a portion or all of map A overlaid with a portion or all of map B, such that the matching restaurants are pinpointed as flags on the map. This process can be extended to overlay many maps atop one another, to give the impression of a very information-rich map. However, a problem with this technique is that its very simplicity restricts its usefulness. Since the process of overlaying maps merely provides a visual illusion of a single integrated map, the map items are not themselves related between the various maps. As such, the overlay map is limited to providing a simple visual impression. It cannot be used for further exploration by the user, since it does not contain the necessary relationship information to jump from one map item to the next. Additionally, because in an overlay the relationships between map items are essentially ignored, there may be problems with accuracy, i.e. features may simply not line up properly in the final image. The commercial applications for this type of map are generally limited to providing the map displays that are familiar to users of Yahoo, Citysearch, Google, and other online directory and information services.

An additional concern with successfully integrating map information is maintaining consistency between the various data sets. When a single application uses information gathered from a variety of data collection efforts, there is always a risk of losing consistency. This risk is present even if the data is collected from in-house resources, but is magnified when the data is collected from other third-parties. One approach might be to maintain or store all of the desired information in a common repository or database. However, as increasing amounts of data are added the database could become quite complex and cluttered, so that performance and maintenance requirements would become unacceptable. Ownership rights to the data would also become more complex, in that many of the third-parties might prefer to retain complete control and ownership over their particular data, and would not wish to have their data usurped into a common database. In many instances, the third-party is also the entity that is most capable of maintaining the accuracy and freshness if their particular data. This accuracy could be lost if the data was integrated into a monolithic database that no longer received the frequent updates from the original data source. These considerations of accuracy and consistency come increasingly into play when the issue of geospatial data is considered, since addressing this issue also requires thinking sociologically, i.e. that the highest quality data is generated by those with a vested interest in it. For example, a hotel chain who is trying to attract customers considers it extremely important to provide their customers with accurate directions, indeed their business is dependent on this functionality. For some vendors an interactive local map may be one of their most important source of advertising. Local knowledge is also considered the best knowledge when it comes to representing local information, such as neighborhood or community information. In each of these instances, a third-party generating its own data source may be better positioned to create and update locally-oriented or focused data, than might a centralized map data company operating a single database.

Despite the disadvantages of centrally-stored or monolithic map databases, if a company is to provide the end user with the desired integration of information from a variety or data sources, then there must still be some form of central coordination of this data. Central coordination guarantees that the data collection efforts are standardized and comprehensive. This is an important element in producing a quality product with consistent, appealing appearance over large geographic areas that software applications can then use. As a rule of thumb, the looser, or less rigid a particular data model or schema is then the easier it is to import data into that schema. Conversely, the more rigid a schema is, then the more difficult it is to import data, and the more likely that information will be lost during the import process. This is the problem that occurs when one enforces a particular world view. While some common data structures are needed to provide order, the world which the map represents is self-contradictory at times and can be seen from many different perspectives. Ideally, the digital map should impose enough order within it's schema to meet the functional requirements of the application, and to generate an aesthetically pleasing appearance. Imposing a rigid schema beyond this is detrimental.

Another important element of digital map-making is quality control. Automated data collection and processing algorithms can manipulate information in a speedy, logically consistent fashion that is impossible for humans to match. However, there is no computerized substitute for the intelligence of a human in identifying and correcting certain types of data problems. A human operator is also better able to determine whether a digital map is a fair representation or not of the world it purports to duplicate. Therefore, in any mapping environment having the best tools for visualizing that data is critical for quality. As described above, a third party may be in the best position to perform these necessary quality control checks and corrections.

The reader will note that, if taken separately, many of these observations suggest opposing considerations, notably the desire to create a digital map offering that integrates various data sources, while simultaneously allowing different entities to retain control over those various data sources. An optimal design should balance these considerations properly. In particular, the design should allow for a consistent and flexible means of integration, while simultaneously allowing control over some data sources to remain with those entities that are best suited to ensuring the data's quality and accuracy. Often, this will mean sharing control for the final overall map product between the digital map provider company, and one or more third-party companies. Another important point to consider is that, in order to be useful in an end user application, any third-party or externally-sourced application data must conform or line up with, for example, the road network used within the digital map, must be accessible through a single common simple interface, and must allow for querying in standard ways (for example, by identifier, coordinate window, address, object type or classification, and/or relationship to another object). To date, no available system has provided these benefits.

### SUMMARY

As disclosed herein, a system and method for providing digital map information is described. The “Virtual Database System” (VDB) balances the apparently opposing considerations between allowing integration of map data, often from various sources, in a consistent manner for supply to an end user, while simultaneously ensuring that the entity best able to support a particular data source retains control over that data. In particular, the VDB allows sharing of control and ownership (or in some instances delegating control and ownership) for each component that will go into the final overall map product between a digital map provider and one or more third-parties, or between several third-parties. In accordance with an embodiment, the VDB environment enables third-party data providers to easily associate or geocode their data or “third-party-files” onto a digital map provider's “base map” or “file-of-reference”, thereby allowing for the creation of dynamic relationships between digital map features and other third-party data providers. The VDB can also be accessed by application providers to purchase and retrieve seamlessly integrated data from multiple vendors through a single mechanism, and then provide that data to an end user. As disclosed herein a file-of-reference can be a geospatial database, data structure, document, or digital map used for storage of geographic data. Similarly, the third-party file can also be a geospatial database, data structure, document, or digital map used for storage of geographic data. In certain embodiments, the integration can be performed in a dynamic or real-time fashion, receiving up-to-date information from the various sources, creating links, and composing virtual maps, as needed or on-demand. An additional benefit is that, since the information is linked between the map providers and the various third parties, whenever an item of information or a link between items is updated in either the file-of-reference or in one of the third-party files, that updated information can be propagated back to all of the third-parties for further use by them in their own software applications. So, although each party maintains control over their data sets, if they so choose they can automatically receive updated or corrected information from each of the other parties, and can then choose to update their data sets as they see fit. In this way, everyone benefits from the opportunity to automatically share updated information.

### BRIEF DESCRIPTION OF THE DRAWINGS

FIG. 1 shows an illustration of a Virtual Database environment in accordance with an embodiment of the invention.

FIG. 2 shows an illustration of a means of integrating multiple map databases in accordance with traditional methods.

FIG. 3 shows an illustration of a means of integrating multiple map databases using a Virtual Database system in accordance with an embodiment of the invention.

FIG. 4 shows an illustration of the interaction between different parties using the Virtual Database system or environment in accordance with an embodiment of the invention.

FIG. 5 shows a flowchart of a method of using a Virtual Database system in accordance with an embodiment of the invention, wherein location identifiers are first created upon creating the virtual database.

FIG. 6 shows a flowchart of a method of using a Virtual Database system in accordance with an embodiment of the invention, wherein preexisting location identifiers are used in creating the virtual database.

FIG. 7 shows an illustration of a Virtual Database system architecture in accordance with an embodiment of the invention.

FIG. 8 shows a flowchart including steps in a general method of using a Virtual Database in accordance with an embodiment of the invention.

FIG. 9 shows an illustration of how third-party data can be integrated with additional content in the Virtual Database, at varying degrees of confidence in accordance with embodiments of the invention.

FIG. 10 shows an illustration of a Virtual Database that uses ULROs, in accordance with an embodiment of the invention.

FIG. 11 shows steps in a general method of using a Virtual Database in accordance with an embodiment of the invention.

FIG. 12 shows additional steps in a general method of using a Virtual Database in accordance with an embodiment of the invention.

FIG. 13 shows additional steps in a general method of using a Virtual Database in accordance with an embodiment of the invention.

FIG. 14 shows additional steps in a general method of using a Virtual Database in accordance with an embodiment of the invention.

FIG. 15 shows additional steps in a general method of using a Virtual Database in accordance with an embodiment of the invention.

FIG. 16 shows additional steps in a general method of using a Virtual Database in accordance with an embodiment of the invention.

FIG. 17 shows additional steps in a general method of using a Virtual Database in accordance with an embodiment of the invention.

FIG. 18 shows additional steps in a general method of using a Virtual Database in accordance with an embodiment of the invention.

FIG. 19 shows steps in a method of using a Virtual Database with ULROs in accordance with an embodiment of the invention.

FIG. 20 shows additional steps in the method of using a Virtual Database with ULROs in accordance with an embodiment of the invention.

FIG. 21 shows additional steps in the method of using a Virtual Database with ULROs in accordance with an embodiment of the invention.

FIG. 22 shows additional steps in the method of using a Virtual Database with ULROs in accordance with an embodiment of the invention.

FIG. 23 shows additional steps in the method of using a Virtual Database with ULROs in accordance with an embodiment of the invention.

FIG. 24 shows additional steps in the method of using a Virtual Database with ULROs in accordance with an embodiment of the invention.

FIG. 25 shows additional steps in the method of using a Virtual Database with ULROs in accordance with an embodiment of the invention.

FIG. 26 shows additional steps in the method of using a Virtual Database with ULROs in accordance with an embodiment of the invention.

FIG. 27 shows an illustration of an example application of the VDB system.

FIG. 28 shows another illustration of an example application of the VDB system.

### DETAILED DESCRIPTION

As disclosed herein, a system and method for providing digital map information is described. The “Virtual Database System” (VDB) balances the apparently opposing considerations between allowing integration of map data, often from various sources, in a consistent manner for supply to an end user, while simultaneously ensuring that the entity best able to support a particular data source retains control over that data. In particular, the VDB allows sharing of control and ownership (or in some instances delegating control and ownership) for each component that will go into the final overall map product, between a digital map provider and one or more third-parties, or between several third-parties. In accordance with an embodiment, the VDB environment enables third-party data providers to easily associate, geocode or otherwise locate their data or “third-party-files” onto a digital map provider's “base map” or “file-of-reference”, thereby allowing for the creation of dynamic relationships between digital map features and other third-party data providers. The VDB can also be accessed by application providers to purchase and retrieve seamlessly integrated data from multiple vendors through a single mechanism, and then provide that data to an end user. As disclosed herein a file-of-reference can be a geospatial database, data structure, document, or digital map used for storage of geographic data. Similarly, the third-party file can also be a geospatial database, data structure, document, or digital map used for storage of geographic data. In certain embodiments, the integration can be performed in a dynamic or real-time fashion, receiving up-to-date information from the various sources, creating links, and composing virtual maps, as needed or on-demand. An additional benefit is that, since the information is linked between the map providers and the various third parties, whenever an item of information or a link between items is updated in either the file-of-reference or in one of the third-party files, that updated information can be propagated back to all of the third-parties for further use by them in their own software applications. So, although each party maintains control over their own data sets, if they so choose they can automatically receive updated or corrected information from each of the other parties, and can then choose to update their data sets as they see fit. In this way, everyone benefits from the opportunity to automatically share updated information.

Depending on the implementation, the Virtual Database System allows map information or third-party files from many sources to be intelligently combined in real-time, and then presented to the user in response to a user's request. In this manner, the map information is only retrieved, linked, and integrated at the time of receiving and responding to the request, ensuring that the information provided is as up-to-date as possible. In other implementations, the Virtual Database System allows map information from many sources to be intelligently combined at product build-time, i.e. when a particular map-based software product is built for shipping to a customer. The VDB ensures that the latest information is integrated into the product at the precise time of building. In yet other implementations, the Virtual Database System can be used to automatically communicate multi-sourced map information to other systems, for further use by those systems.

Since the information used to produce the map is stored virtually, i.e. it is dynamically created in response to a request, it need not be centrally located within a single database structure. In some implementations however, it may still be desirable to place in a cache or to otherwise store this virtual map for subsequent uses, particularly when the system is responding to many subsequent requests for the same map data.

Creating a virtual map also allows the various pieces of the information, i.e. the third-party files, to be sourced and maintained by different commercial entities, and to be modified or updated independently of one another. Practically speaking, from the perspective of an end-user, the user perceives a single map, replete with all of the information that is important to them. From the perspective of a data provider, the system enables the sharing of information that is otherwise owned and controlled by multiple entities, to provide a single uniform product offering.

In accordance with an embodiment, the Virtual Database System is of particular use in combining the digital base map offering of a digital map data provider (for example Tele Atlas or another commercial mapping company, which are generically referred to within the context of this document as a “digital map provider”), with the offerings of one or more third-parties (for example companies such as Yahoo, Google, Citysearch, Expedia, Travelocity, or Zagat, that specialize in travel-related, neighborhood, local, yellow pages, directory, or similar information). Using the VDB approach, the digital base map or file-of-reference information that is provided by the digital map provider is combined with the data from the various third-parties either during the build of a particular product, or in real-time to create a virtual digital map. For greater precision, third-party data providers can geocode their data files consistent with the base map or file-of-reference. For example, they can use coinciding latitude/longitude information, or can map addresses in the file-of-reference with a ULRC in the third-party files, or can use a combination of object and location codes. Third-party data providers can also place features spatially aligned with the base map or the file-of-references by geographically coding or associating those features with the geographical locations within the base map.

In accordance with some embodiments, the Virtual Database System also enables third-party data providers to link their data to a feature within the base map or file-of-reference through the use of a unique identifier. Since integration is performed in a dynamic fashion, or upon a request to build an application, whenever a change to one data source is made (for example, when a change is made to a restaurant review in a Zagat's database), the information can be dynamically embedded into the virtual map at the time the user makes the request.

In accordance with some embodiments, the linking between the file-of-reference and various third-party data sources can be provided by universal location reference objects (ULROs). As described in further detail below, a ULRO comprises a permanent identification code designed to identify a selected location. In turn, a location can be associated with one or more geographic items. ULROs can be employed to establish traversable links or connections between the digital base map or file-of-reference, and the third-party data files. In this context the file-of-reference is a geospatial file used for permanent storage of a file owner's geographic data. The third-party-file is a geospatial file used for permanent storage of a third party's geographic data. Additional information about the use of ULROs is provided in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference. In those embodiments that use ULROs or similar universal objects, the ULROs may be considered an example of a technology that provides the linkage between a map provider's file-of-reference and the various third-party files. The VDB may then be considered a technology that utilizes such linkage in generating virtual maps.

The goals of the Virtual Database System include improving at least three aspects of data handling capabilities in relation to third-party map data suppliers: dynamic integration, in that a digital map data provider and its third-party partners can share data, yet still retain control over their data, so that they can continue to update their individual databases according to their own product cycles; increased map quality, by delegating control to those best suited to detecting data discrepancies and ensuring a close linking between the core digital map data and the third-party's data during the integration process; and ease of sharing, by enabling a common framework that brings together data from multiple sources in a consistent manner.

An additional benefit of this approach is that the third-party data providers do not need to code their information using the precise latitude and longitude coordinates used in the base map. Instead, they can benefit from and provide information to other third parties. For example, a third-party may provide information about map features, such as restaurants, or parking garages within the map. Another third-party may provide information about attributes for those map features, such as the opening times of particular restaurants. Another third-party may provide the links that relate a particular restaurant to the closest parking garages to that restaurant. The corresponding information may all be linked together in the final virtual map, to present a map from the third-party's perspective, rather than that of the digital map provider. In addition, during the creation of the virtual database, features, and shadows of features, that are not already in the base map can be dropped onto the map using a variety of links to any number of third-parties.

These and other benefits will be evident from the description included herein.

### Glossary of Terms

The following section defines some of the terms used in the context of this document:

Digital Map Provider—A digital map provider is a commercial, governmental, or other type of entity or company which develops, maintains, and provides a file-of-reference or digital base map, or supplies the data that comprises a file-of-reference or digital base map. Digital map providers can also act as third-party file providers in certain instances. Examples of commercial digital map providers include Tele Atlas, and other mapping companies.

Third-Party—A third-party, third-party data supplier, or third-party data source is a commercial, governmental, content provider, or other type of entity, usually separate from the digital map provider, that provides third-party data or content for use with the file-of-reference or digital base map. If a third-party participates in a joint data-providing operation with the digital map provider, then they may both be considered third-party partners.

File-of-Reference—A file-of-reference is a geospatial database, data structure, document, or digital map used for permanent storage of a document owner's geographic data. A file-of-reference can typically be transformed into other formats that may be more appropriate for certain applications. The term “permanent” as used herein is not intended to imply static, since the data can of course be updated, but instead the term indicates that the data in a file-of-reference is in a more “permanent” storage than the data that is dynamically created in a virtual map in response to a request. In accordance with an embodiment there is only one file-of-reference database. Each other data source or geographic database are then considered third-party files. However, these are descriptive labels more than anything else, since in other embodiments any of the data files or data sources can act as the file-of-reference, treating the other data files as the third-party files. As used herein, a file-of-reference may sometimes be referred to as a “digital base map”, to illustrate that it is typically provided and marketed by the digital map provider as a digital map.

Third-Party File—A third-party file is also a geospatial database, data structure, document, or digital map used for permanent storage of a document owner's geographic data, the difference being that the data in a third-party file is being supplied by a third-party for use with the file-of-reference. As described above, these titles are intended as descriptive labels more than anything else, since in other embodiments any of the data files or data sources can act as a third-party file, treating the other data file as the file-of-reference.

Virtual Database/Virtual Database System—The virtual database is a means of treating data distributed over multiple databases as if they belonged to a single database. The system that provides a virtual database is then properly referred to as a virtual database system (VDB). The terms “virtual database” and “virtual database system” are somewhat analogous in that they each refer to a system, means, or technique for creating virtual databases or virtual maps, in which objects and features within both a file-of-reference and one or more third-party files, are linked to form a virtual database. In those embodiments that utilize ULROs or similar universal objects, the ULROs may be considered an example of a technology that provides the linkage between a map provider's file-of-reference and the various third-party files. The VDB may then be considered a technology that utilizes such linkage in generating virtual maps.

Virtual Map—A virtual map is an interim database, or in some instances the output of a VDB, and is conceptually the same as the virtual database described above, i.e. it is a means of treating data distributed over multiple map sources as if they belonged to a single map. The term “virtual map” has more real-world connotation that the term “virtual database”, and is essentially a complex digital map. In addition, since the virtual map is created dynamically, at run-time, from a number of otherwise separate sources, it is more flexible, easy-to-update, and thus more useful than a mere compendium of map data.

Integration Database—In accordance with some embodiments, the integration database also referred to herein as a cross-reference (XREF) database, is a database or data structure that integrates the file-of-reference with the third-party files or the third-party data belonging to one or more third-parties. In some embodiments, the integration database is an actual database structure, stored on a physical medium. In other embodiments, the integration database is a dynamically created data structure that links the file-of-reference and the third-party files.

Application Database—In accordance with some embodiments, the application database is the delivery vehicle of the virtual map data from the various parties to the end user. Depending on the particular implementation, the application database can take a variety of different forms, including a traditional database format, a Web page, or some other means of data presentation.

ULRO—In those embodiments that utilize a universal location record object (ULRO), the ULRO comprises a permanent identification code and sufficient information designed to uniquely identify a particular location within a file-of-reference or third-party file. A location, in turn, can be associated with one or more geographic items. ULROs can be employed to establish traversable links between the file-of-reference and the third-party-files for a broad range of database formats. ULROs can be similarly employed to establish traversable links between two or more third-party files. In some embodiments, the ULRO can refer to the location of either a single map feature, a segment of a map line feature, or a collection of related map features. In some embodiments, the ULRO can encode location information about the object referred to, or it can be simply an assigned number. A map can include a plurality of features which each share the same location, and the same ULRO. Once a ULRO is retired, it cannot be reused. In those embodiments that use ULROs or similar universal objects, the ULROs may be considered an example of a technology that provides the linkage between a map provider's file-of-reference and the various third-party files. The VDB may then be considered a technology that utilizes such linkage in generating virtual maps. Additional information about the use of ULROs is provided in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference.

Map—As used herein, the term “map” is a generic term that is used to refer to a geospatial database, digital map, or the map data contained therein.

Map Object—A map object is a map item, or more appropriately a data object instantiated within a geospatial database or map.

Feature/Geographic Feature—A geographic feature, also referred to herein simply as a “feature”, is an idealized map representation of an actual object from the real world, which is useful to that map representation. Features can have a dimension and most often but not always have geometric representations. Features might not be actually visible in the real world: such as borders or intersections, yet notwithstanding this they can still be represented in a map model. Features have a type and a class, which together allow the system to distinguish one feature from another, while also preserving similarities between features that are alike.

Dimension of Feature—Features are often represented in the map model in a more simple way than in their full “real world” complexity. Often the real world complexity is more of a distraction than an asset to a model, which is just trying to capture a few salient aspects of the real world in order to perform some particular function. Thus, the dimension of a feature does not reflect the real world truth, but rather what the representation has rendered. In accordance with an embodiment, the five dimensions that feature are divided to include: point features, line features, area features, volume features, and complex features. Real world features which are represented as points are known as point features. For example, a restaurant (even though it is, in the real world, a volume object with complex shape), when represented in the map model is conveniently represented as a point feature. So is, for example, a junction where two or more roads elements cross each other. Line features are represented as linear or simple curved segments (and as such have an extent which runs between point features or intermediate shape points). Roads, borders, train lines, and rivers are some examples of line features. Even though, in the real world, these objects are not razor-edge thin, in the map model they are represented as idealized center lines, ignoring their actual width. Lakes, parks, and administrative areas are examples of area features. Volume features, such as buildings, (absent from most map models) are represented as a construction of connected area features in a way that resembles the real world, although often with much less detail. Lastly, complex features are features which are not “atomically” defined.

Type of Feature and Class of Feature—Types and classes of features are subcategories of features that enable different features to be distinguished. Roads, rivers, train tracks, cities, counties, mountain peaks, bus stops, intersections, bridges, restaurants, hotels, rest areas are but a few examples of types of features. In most commercial map models there may be thousands of different feature types. For example, the ISO-GDF (Geographic Data File) map format is one standard format, which, among other things, attempts to list a corpus of well-known feature types. Complete details of the GDF format are described in the ISO specification “ISO 14825: Intelligent Transport Systems—Geographic Data Files (GDF) Overall Data Specification”, incorporated herein by reference. Within a particular type of a feature there can also be a variation. For example, there are different classes of roads in the world: highways, major roads, minor roads, rural roads, residential roads, slip roads, dirt roads, and goat trails. While these are all of the feature type “road”, they differ in their various classifications—hence a feature class is subordinate to the feature type.

Geometry of Feature—In the computer map model, features often have a geometrical representation of the feature's shape. For example, point features are representation by a single node. Line features are often represented by linear segments—edges—which can run through a sequence of shape points. Area features can be represented by a collection of faces, each of which consists of edges delineating its boundary. Area features can be disconnected or can even have holes in them. Volume features can be represented by volume geometry, which might contain cavities.

Topology—A topology is a set of mathematical properties that are used as a means of capturing connectivity relationships between features which remain true even when the geometry (shape) of the feature might undergo some change. Geometries of some dimension are bounded by geometries of lesser dimension. For example, volumes are bounded by areas; areas are bounded by linear segments; linear geometries are bounded by points. Conversely, points are co-bounded by linear geometries; linear boundaries are co-bounded by areas; and areas are co-bounded by volumes. Topology can be an aspect of the features themselves, or of the geometry which captures their shape.

Simple Feature—Point features, line feature, area features, and volume features are referred to as simple features, since they are directly modeled by assigning geometrical shapes to them.

Complex Feature—In contrast to simple features, complex features can be indirectly defined by other features (either simple or complex), or by direct geometrical rendering. For example, the state of California can be represented not by running its boundary with shape points (which would make it a simple area feature), but rather as the sum of its counties (which themselves can be simple or complex features). California State, rendered as a complex feature, is a single feature, which is defined in a complex way by referring to other features. Roads which consist of two road elements—one in each direction of traffic—are another common example of a complex feature. When two complex roads meet, a complex feature is declared, namely, the complex intersection. Often an intersection can be thought of as four junctions, where the simple road elements cross each other.

Plurality of Features—Both the simple features and complex features described above are examples of single features. It is, however, sometimes useful to think about several features at once, hence creating a plurality of features. For example, the collection of all of the restaurants in San Francisco, or all of the counties in California serve as examples of a plurality of features. Note that the plurality of features (for example, all the counties in California) is a different concept from the single complex feature of the State of California (although in this example they do have the same geometric footprint).

Sub-Set of Feature—It is sometimes convenient to identify a portion, sub-set, or a part of a single feature. Sometimes such parts can be features in their own right, but at other times, such parts are mere fragments, which on their own would not be actual features. Examples of a sub-set of a feature include a single county of the State of California feature, a segment of road element spanning just a fraction of a block between two intersections, or floors 4 through 17 of a 30-story building.

Attribute—Features, plurality of features, and sub-sets of features can have attributes. Attributes are provided in large catalogs, and there can be thousands of different attributes applying to features in a commercial computer map model of the real world. The attribute type is what captures the different attributes from the catalogue. Speed limit, length, direction of traffic flow and restaurant opening hours are but a few examples of such attributes.

Relationship—Relationships comprise two or more features “participating” in some meaningful connection to each other. For example, a road element might split into several road elements at some junction, and hence all of those features are in a “fork” relationship to each other (each feature playing a different role). Relationships are also provided in large catalogs, and, as with attributes, hundreds of such relationships are possible in actual commercial digital map models. Not all relationships are geometric, since many are developed by modeling real-world activities. For example, the restaurant that validates parking for a particular parking garage represents one type of business relationship between two features.

Geographic Item—For the purpose of this description, the term “geographic item” is a non-ISO standard term. A geographic item is defined herein to be either a feature, a plurality of features, a sub-set of a feature, or an attribute.

Location—The location is defined as where a feature is in the real world, which is a distinct concept from the feature itself. For example, while a feature may be a particular restaurant, its location can be specified as some latitude, longitude (lat/long) coordinate pair, or coordinates from some similar geodetic referencing system, or as a human readable address, (for example “322 Battery Street in San Francisco”). Locations should not be confused with features, or with the other geographic items associated with the locations.

Hierarchy of Features—Features often form a hierarchy of construction. For example, a country may be comprised, or made up, of States or Provinces, while States may be comprised of counties etc. In a similar manner, roadways are made up of many block face road elements. The roads and parks and buildings of the complex area which comprise “the Stanford University campus area” are parts of the larger feature. The hierarchy of features is a special case of a relationship between features, and it can be explicitly captured and represented, or not.

Point of Interest—A point of interest (POI) is a special type of point feature. In particular, the POI is a feature type that can comprise other, more specific types, such as a restaurant, hotel, or museum.

Relationship Link—In accordance with some embodiments, a relationship link is an entry in a table that defines a relationship between data objects. In embodiments that utilize a ULRO, a relationship link can relate either two ULROS, or a ULRO and a third-party data that lacks a ULRO (for example, a filename or a URL). Not every embodiment uses relationship links.

Marker—In accordance with some embodiments, markers (or “location markers”)_can be used. To associate individual map features, a segment of a map line feature, or a collection of related map features. These features can be located either in a database maintained by the digital map data provider or a third-party vendor; however, the digital map data provider will maintain the markers. In some embodiments, the relationship information is not stored in the ULRO, and in these instances a marker is appropriate. However, in most instances a marker is not necessary or desirable. Not every embodiment uses markers.

Object Marker—Object markers are a particular type of marker, and as described above, may be used in certain embodiments as an optional feature. In accordance with some embodiments, an object marker is a reference that associates a location marker with a data object. The data objects can be located either in a file-of-reference or database maintained by the digital map data provider, or it can be located in a third-party file maintained by a third-party. Not all embodiments use object markers.

Relation Marker—Relation markers are a particular type of marker, and as described above, may be used in certain embodiments as an optional feature. A relation marker (or “relationship marker”) is a relationship between data objects. Not all embodiments use relation markers.

Metadata Registry—In accordance with some embodiments, a metadata registry can be used. In those embodiments that utilize a ULRO, the metadata registry is a registry that identifies third-party data providers, their data content, coverage areas, or quality rating, and an applicable range of ULROs assigned to them. Not all embodiments use metadata registries.

### Virtual Database Environment

Generally described, an embodiment of the present invention provides a virtual database system or environment. The virtual database environment allows spatial information to be “joined” in real-time. This process is similar to that used in a traditional database environment where a set of database tables are joined to collectively respond to a request from a user that would otherwise span many tables. The process differs substantially from the traditional overlay type of map-combining described in the background section above. Whereas an overlay map lacks any relationship information, the virtual database environment provides a means of linking every item within the combined or joined map, including the points, locations, areas, buildings, or commercial properties, together with any other information that can be associated with those items. To the end user, the resultant virtual database or virtual map may have the visual appearance of the traditional overlay map. However, unlike an overlay map, when using the virtual database approach the user is able to click on one map item to reach any other, linked, map item. Indeed, all the information related to a map item is available via the linking mechanism. An additional benefit over traditional overlay technology is that, while an overlay map is entirely reliant on geographic information, which could be inaccurate, the virtual database approach is not so constrained

Since in a virtual database system, some information may have been retrieved from a file-of-reference, while other information may have been retrieved from a third-party file, the technique allows for linking between data that is owned, controlled, and maintained by different commercial entities. An example of the type of linking mechanism that may be used within the virtual database environment is described in copending U.S. patent application “SYSTEM AND METHOD FOR ASSOCIATING TEXT AND GRAPHICAL VIEWS OF MAP INFORMATION”; Inventor: Gil Fuchs; application Ser. No. 10/209,750; filed Jul. 31, 2002, and incorporated herein by reference. As described in that patent application, map items are linked by semantic relationships, allowing an attribute of one map item to be linked to an attribute of another map item. However, the linking in that instance was mostly between map items in a single map. An example of the type of linking mechanism that can be used within the virtual database environment and between multiple maps or multiple data sources is described in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference.

The utility of the virtual database may be considered in the example of the restaurant application described above. If a company wishes to provide an online restaurant-search utility, then using the virtual database approach they can provide a link to a first data source or a first map A, which can be a typical geographic map with streets, parks, and other such locations shown thereon. They can also provide a link to a second data source or second map B that contains restaurant information, reviews and the like. In response to a user request for the restaurant map, instead of simply overlaying the maps, the company can retrieve and display map A linked with the data of map B, such that the restaurants are, as before, pinpointed as flags on the map. However, using the virtual database, any element of information associated with that restaurant provided by map B is fully linked to the elements of map A. The virtual database is thus a virtual linking of the different map data sets to create, at least for the temporary time period of responding to a user request, a complex map structure in which all of the map items are linked. Similar to the map overlay process, the virtual database process can present the information of many maps with one another, to give the end user the impression of an information-rich map. However, the map overlay is merely an illusion. Unlike the map overlay-process, using the virtual database approach each subsequent set of data that is linked is also linked by its map items to the other map items in the collection. Furthermore, since one set of data, for example map A, can be received in real-time from one entity, say the digital map provider, while another set of data, for example map B, can be received in real-time from a different entity, say a third-party, the virtual database allows responsibility for, and control of, each data source to remain with the owner of the particular data.

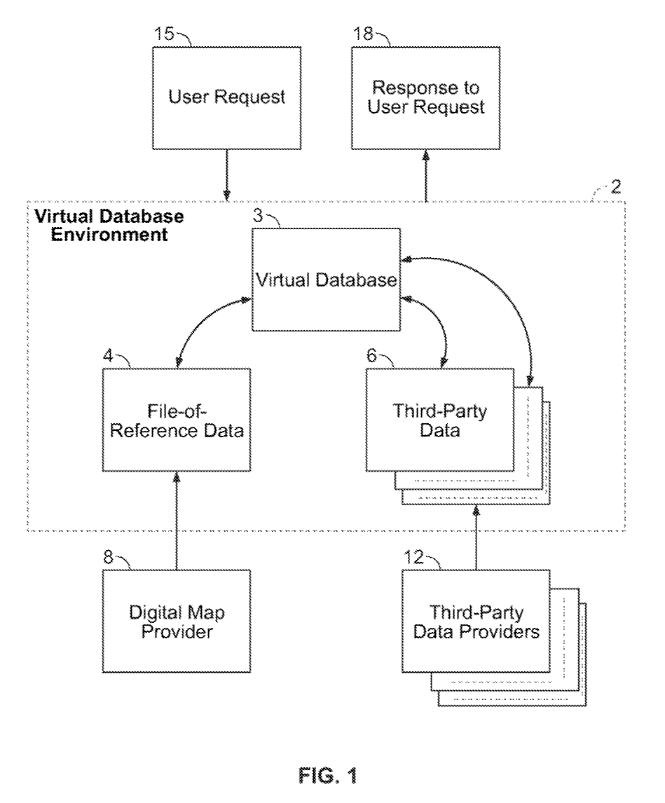

FIG. 1 illustrates a virtual database environment in accordance with an embodiment of the invention. As shown in FIG. 1, the virtual database environment 2 includes a virtual database 3, file-of-reference 4, and one or more third-party files 6. As described above, the file-of-reference is provided by a digital map provider 8, a commercial, governmental, or other entity or company which develops, maintains, and provides a file-of-reference or a digital base map. The third-party file is provided by a third-party commercial or other entity 12, which is usually separate from the digital map provider, and which retains control over the particular data in their file. The file-of-reference and third-party files can be geospatial databases, data structures, documents, or digital maps. However, the above are descriptive labels more than anything else, since in other embodiments any of the data files or data sources can act as the file-of-reference, treating the other data files as the third-party files. The virtual database is a means of treating data distributed over the file-of-reference and third-party files as if those data sets belonged to a single database. Any system that provides a virtual database in this manner can then properly be referred to as a virtual database system.

In those embodiments that use ULROs or similar universal objects, the ULROs may be considered an example of a technology that provides the linkage between a map provider's file-of-reference and the various third-party files. The VDB may then be considered a technology that utilizes such linkage in generating virtual maps. In accordance with an embodiment, the file-of-reference includes a database of geospatial or map information, including for each item in the database some identifying information. This identifying information can be the name, latitude and longitude of the item. In those embodiments that use ULROs or similar universal objects, the ULROs can be include identifying information for the item by specifying the item's ULRC.

In accordance with an embodiment, each file-of-reference also includes a database of geospatial or map information, including for each item some identifying information. This identifying information can similarly be the name, latitude and longitude or ULRO. The virtual database is created in response to a user request 15, or if building an application then in response to a request to build the application. The response to the user request may be an actual displayable map, some map-related information, a web packet (such as an XML message), an API function call, or another form of response 18.

In accordance with one embodiment, during creation of the virtual database, “ghost” objects or shadows can be created in memory corresponding to the items in the file-of-reference. These objects are then linked as necessary to corresponding items in the files-of-reference, so that they can be populated with third-party data prior to responding to the request. The information used to retrieve information from the various files for each object in memory is the common name, longitude, latitude, ULRO, or other information for that item. Not all embodiments use ghost objects.

Since the virtual database or virtual map is created in response to a request from a user, in accordance with an embodiment the life of the virtual database can be allowed to persist for the life of that user session. After the session terminates, the virtual database can then be erased. A subsequent request will cause the system to create a new copy of the virtual database. In some implementations however, it may still be desirable to place the virtual map into a cache or to otherwise store it for a longer period of time, particularly when the virtual map will be used to respond to many subsequent requests for the same map data.

If the digital map provider and the third-party shares a common file format, then integrating the two sets of data is essentially a one-to-one task. However, since a goal of the present invention is to allow for separation of control over various data sets, it is more likely that the digital map provider and the third-party will not share a common file format. In order to access information in a third-party file, the third-party provider must provide an interface that allows for common data retrieval and linking. Alternatively, the digital map provider can provide an interface for the third-party to use.

In those embodiments that use ULROs or similar universal objects, if the system receives third-party data that does not have an existing ULRO, it can assign a new ULRO to the item.

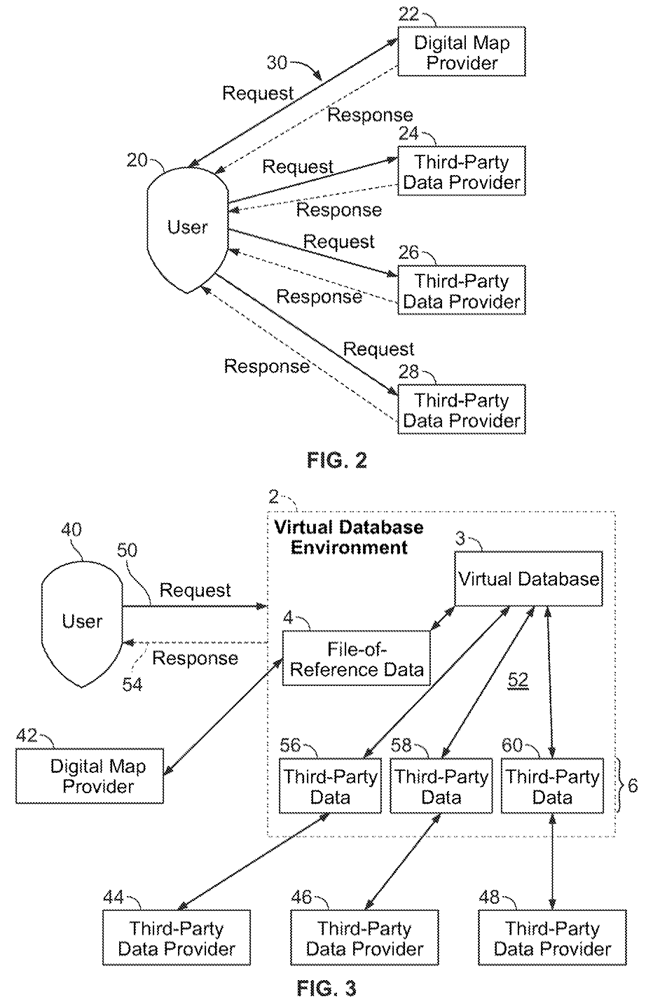

FIG. 2 and FIG. 3 illustrate the benefits of the virtual database system over traditional third-party map integration solutions, from the perspective of the end-user. As shown in FIG. 2, when using a traditional integration solution, the user 20 must make multiple requests/responses 30 to each of the plurality of digital map providers 22, and third-party data providers 24, 26, 28. As referred to herein, a “user” may be an actual person, or may be a software program, computer system or other requestor of map-based information. In some instances, automated processes or layers can package the multiple requests and responses (using an overlay process) so that it appears to the end user as a single set of data. However the data is still received independently from the third-party data providers, which leads to the problems of reconciling and fully integrating the data, as described above. As shown in FIG. 3, when a virtual database environment is used, the user 40 need only make a single request 50, and receive a single response 54. The virtual database environment takes care of integrating the data from each of the plurality of digital map providers 42, and third-party data providers 44, 46, 48, into a virtual database 3. In accordance with an embodiment file-of-reference data 4 from the digital map provider is linked 52 in real-time with third-party file data 56, 58, 60, from the third-party data providers, to populate the virtual database and to dynamically respond to the user request.

A point to note is that, whereas FIG. 3 illustrates a process wherein a user request is received, and then the appropriate links to third-party sources are invoked and the resulting set of information is used to create the virtual database, it will be evident that in other embodiments, the integration of data can be performed in a different manner. For example, in accordance with some embodiments, at the time of receiving a first user query a preliminary set of links can be created to an initial set of third-party data. If the user makes a more detailed request, then additional sources can be included, with additional data, and additional links, to satisfy that more detailed request. In accordance with other embodiments, “alliances” of third-party data can be created, so that, for example when a third-party A's data source is used to create the virtual database, then a third-party B's data source is also used. Other embodiments and implementations regarding the timing and the scope of the linkages will be evident to one of skill in the art.

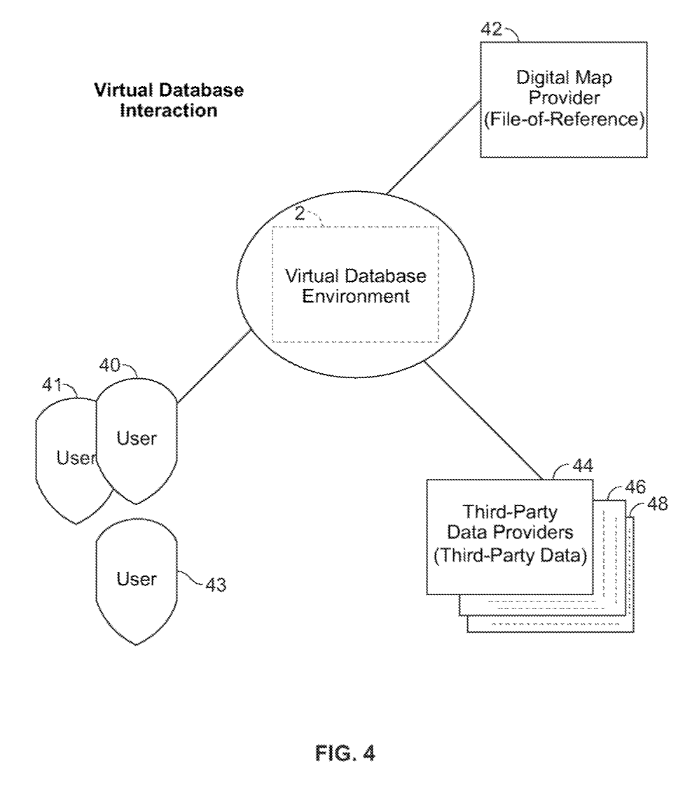

FIG. 4 illustrates how the different entities interact within the virtual database environment. As shown in FIG. 4, a plurality of users 40, 41, 43, together with one or more digital map providers 42, and third-party data providers 44, 46, 48 share map-related data via the virtual database environment 2. As described above a “user” may be an actual person, or may be a software program, computer system or other requestor, of map-based information. In addition, the labels used in FIG. 4 are descriptive labels more than anything else, since in other embodiments any of the data files or data sources can act as the file-of-reference, treating the other data files as the third-party files.

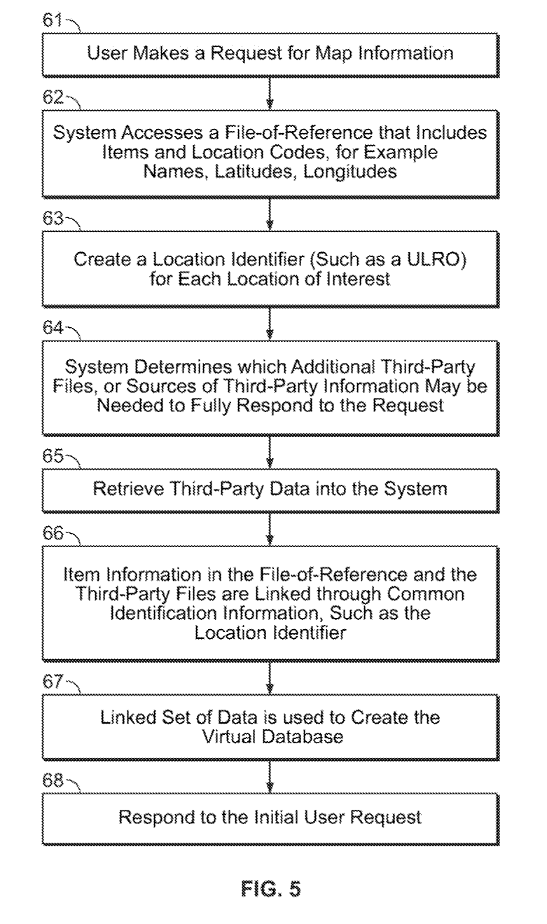

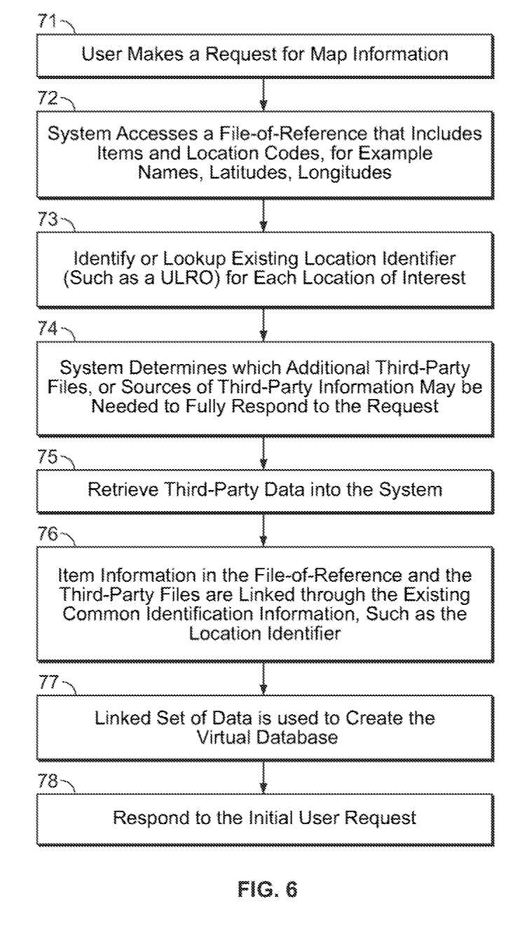

FIG. 5 and FIG. 6 illustrates a flowchart of a process used by the virtual database environment in accordance with an embodiment of the invention. As shown in FIG. 5, in step 61, the system allows a user or another system to make a request for map information. Alternatively, the process can be initiated by a request to build an application. Based on this request, in step 62 the system accesses a file-of-reference that includes items and location codes, for example names, latitudes, longitudes, or ULROs. In step 63, the system identifies or creates a location identifier (such as a ULRO) for each location within the map. In accordance with the embodiment shown in FIG. 5, ULRO's can be created at run-time, using some information associated with a particular location. In accordance with other embodiments, such as that shown in FIG. 6 below, ULRO's are not necessarily created at run-time, but are instead already defined in the file-of-reference. Additional information about creating ULRO's is described in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference. In step 64, the system then determines which additional third-party files, or sources of third-party information may be needed to fully respond to the request, and, in step 65, retrieves the third-party data into the system. In step 66, the item information in the file-of-reference and third-party files are linked through common identification information, such as the ULRO or other identifier. In step 67, the fully-linked set of data is then used to create the Virtual Database, and, in step 68, to respond to the initial request.

FIG. 6 illustrates a flowchart of a process used by the virtual database environment in accordance with an embodiment of the invention, wherein location identifies or ULROs have already been assigned to some or all of the locations in the file-of-reference or third-party file. As shown in FIG. 6, in step 71, the system again allows a user or another system to make a request for map information. In step 72, the system accesses a file-of-reference that includes items and location codes, for example names, latitudes, longitudes, or ULROs. In step 73, the system looks up or identifies an existing location identifier (such as a ULRO) for each location within the map. In step 74, the system then determines which additional third-party files, or sources of third-party information may be needed to fully respond to the request, and, in step 75, retrieves the third-party data into the system. In step 76, the item information in the file-of-reference and third-party files are linked through the common identification information, such as the ULRO or other identifier. In step 77, the data is then used to create the Virtual Database, and, in step 78, the system responds to the initial request.

The determination as to which file-of-reference and which third-party sources or files should be included in creating the virtual database can be performed in a number of ways, including, for example, registering each third-party source in a central location or registry, and then including those registered third-party files when creating the virtual database. Alternatively, third-party sources can be registered based on the type of data included therein, so that when a request is received that requires a particular type of data to be returned, then only those data sources that match the data type need be accessed. Other means can include allowing third-party data sources to advertise their data files for inclusion into the virtual database, allowing for dynamic registration of third-party sources. Additional embodiments that allow registration of a third-party source with a file-of-reference will be evident to one of skill in the art.

In accordance with an embodiment, to better assist in the process of linking multiple sources of data, the virtual database environment can utilize foreign objects. Foreign objects may be considered map objects that are provided as third-party data, i.e. they are foreign to the file-of-reference. These foreign objects include foreign attributes, and foreign relationships. Foreign relationships can exist between an object in the file-of-reference and one of the third-party objects, or can exist between two third-party objects. Instead of importing these objects into the file-of-reference to make them local, the Virtual Database environment leaves them as foreign objects. When the virtual map is subsequently created, a pointer, or similar pointer mechanism is then used to provide the mapping. Depending on the implementation, there can be various kinds of mappings.

In a first type of mapping, the file-of-reference does not include its own instance of the map item. In this instance, the join operation can recognize another source for the map item, and create a “shadow” of that item in the virtual database (an in some instances also display the shadow on the map) together with the item's attributes and relationships to all of its neighbors, plus all of the neighbors already in the file-of-reference.

In a second type of mapping, the system allows for recognizing that there exists a foreign object that has some attributes that the file-of-reference doesn't know about, but that some instance of the foreign object already exists. In this instance, the join operation does not import the object itself, but does import the attributes that don't already exist in the file-of-reference. This may be considered an importing of attributes, rather than objects.

A third type of mapping may include the relationship between one foreign object and another foreign object. During the join operation the Virtual Database can add those relationships to any other instance of the object already in the file-of-reference.

It will be evident that these examples of mappings are the ones most commonly used, but other types of mapping can be used. It will also be evident that the term “foreign object” is more of a label than anything else, since in a multi-source environment, the term “foreign” largely depends on which of the data sources is selected to be the file-of-reference (all other databases would then be “foreign”). As described above, in some situations many of the data sources could themselves act as a file-of-reference. As such the term “foreign object” only has meaning within the context of a specific implementation.

In accordance with an embodiment, the relationship between map items is not maintained by pointers, but is instead maintained by means of a universal location reference object (ULRO). As described above, ULROs are described in more detail in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference. Many maps are not of the same electronic format, and so in order to link objects from separate maps, the system must typically perform some form of translation. However, this can be a computationally expensive operation. The use of ULRO provides for quick efficient translation. This particular embodiment of the Virtual Database is useful in scenarios where, for example a first party A identifies a map object as an identifier X, which same object is understood by a second party B as identifier Y. Since the parties may at any time, and independently, change the manner in which they identify their own map objects, it can be difficult to maintain rigid pointers across the different sets of data. When ULROs are used, all of the map objects in the file-of-reference receive these codes, while all of the map objects in foreign maps also receive codes. During the creation of the Virtual Database, the system only has to compare the codes to detect matches between the various objects.

In the various examples provided below, both the use of pointers and universal location references are described to provide linking among the map objects. It will be evident that other implementations could use one, both, or a different one of these techniques. The Virtual Database technique is flexible enough that other forms of mapping between the different sets of data can be utilized.

### VDB Architecture

In accordance with one embodiment, the system comprises two or more databases (or more appropriately data collections or data sources) which together comprise the Virtual Database environment. These databases include an integration database, and an application database. The integration database may be a conventional database that resides between the file-of-reference of a digital map data provider and the third-party data sources, and integrates the file-of-reference with the third-party data, using a combination of mapping, pointers, ULROs, or similar mechanisms. The application database is then the delivery vehicle of this data from the various parties to the end user. As such the application database represents the usable aspect of the VDB. Depending on the particular implementation, the application database may take a variety of different forms, some of which may resemble a traditional database. Alternatively, the application database may use a data format that differs from a traditional database format, for example a Web page or other such means of data presentation.

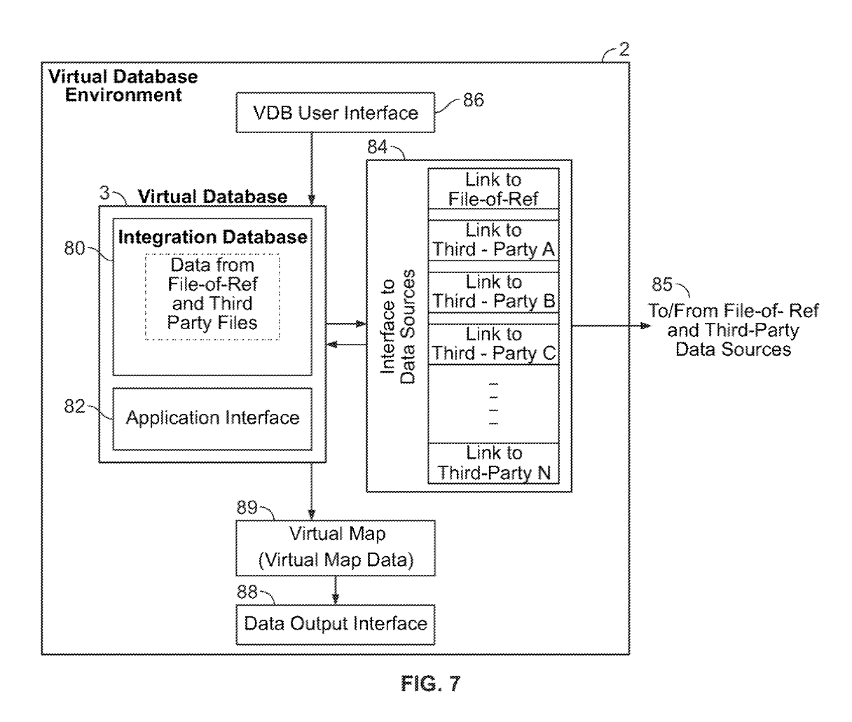

FIG. 7 shows an illustration of a Virtual Database environment or system 2 in accordance with an embodiment of the invention. As shown in FIG. 7, the system comprises a virtual database 3, together with a user interface 86, and a data output interface 88, which may be combined into a single interface. The system further comprises a means of communicating 85 with a plurality of various data sources. In accordance with an embodiment the system includes an interface to the data sources 84, which in turn includes a link to each of the digital map providers' file-of-reference, or the third-party data sources. In response to a user request, or for purposes of communicating map data to another system, a selection of the data sources are chosen, and their map data sets are linked with that of the file-of-reference to create an integration database 80. Each map object within the various map data is linked to the other map objects, either by means of pointers, or in some embodiments by means of a ULRO identifier, to populate the integration database. In accordance with an embodiment, one data source is considered a file-of-reference, having native objects, whereas the other data sources are considered third-party databases having foreign objects. Map objects that are provided as third-party data may be thought of as “foreign objects”, and may include foreign attributes, and foreign relationships. Map objects may also be “partially-foreign” in that some of their attributes are common to the file-of-reference, and some attributes are foreign. During population of the integration database, these foreign attributes and foreign relationships are mapped between the objects in the file-of-reference and the third-party objects. The Virtual Database environment thus is a virtual linking of the different map data sets to create a virtual map structure 89 in memory, in which all of the map items are linked to give to a user the impression of an information-rich map. Unlike the traditional map overlay process, when using the Virtual Database approach each subsequent set of data that is brought into the system linked by its map items to some or all of the other map items already existing in the collection, so that the map is truly a fully-operable and interactive digital map.

As further shown in FIG. 7, the Virtual Database environment includes an integration database 80, and an application database 82. In accordance with one embodiment the integration database may be a single conventional database, or similar data structure, while the application database is the delivery vehicle of all of this data to the end user.

It should be noted that although the above-described components comprise the Virtual Database system, this does not necessarily mean the various components are stored on any one platform or in any one location. Indeed, it is likely that several of the components, particularly the file-of-reference and the third party databases can be stored at, and accessed from, remote locations. Furthermore, while the system shown in FIG. 7 includes an application database, other embodiments may utilize a different means of data delivery, such as a Web-based interface, a web packet (XML message), an API function call, or some other form of data communication.

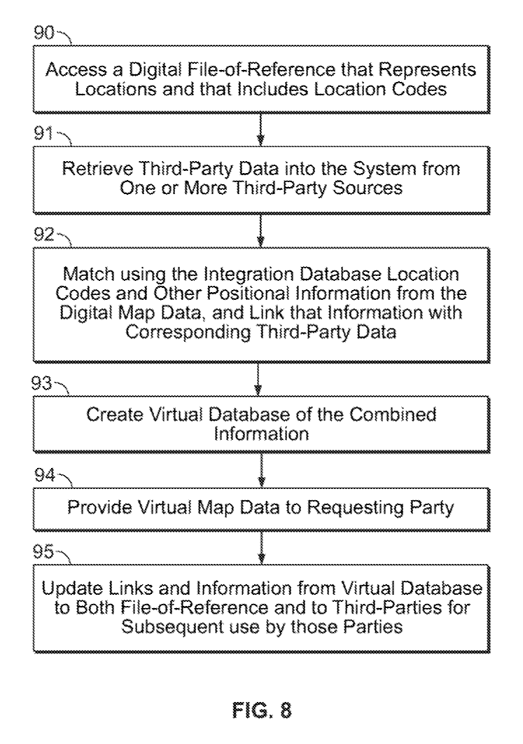

FIG. 8 shows a flowchart of a process of using a Virtual Database environment in accordance with an embodiment of the invention. As shown in FIG. 8, the process includes the step 90, of accessing a file-of-reference that represents a set of locations. In step 91, the system determines which additional sources of third-party information may be needed, and retrieves the third-party data or third-party file into the system. In step 92, the system matches using the integration database location codes and other positional information the information in the file-of-reference with the third-party data. In step 93, this linked set of data is used together with the application database to create the Virtual Database. In step 94, the virtual map data can be provided to a requesting party. In step 95, updated links and information from the virtual database can be provided both to the file-of-reference and to the third-parties for subsequent use by those parties. Again as described above, whereas FIG. 8 illustrates a process wherein the system accesses a files-of-reference, creates appropriate links to third-party sources, and uses the resulting set of information to create the virtual database, it will be evident that in other embodiments, the integration of data can be performed in a different manner. For example, in accordance with some embodiments, at the time of first accessing the file-of-reference or third-party data, a preliminary set of links can be created to an initial set of third-party data. If more detailed information is needed, then additional sources can be included, with additional data, and additional links, to satisfy that more detailed need.

### Optional VDB Enhancements

The above description describes an embodiment of the virtual database environment. Depending on the implementation, the virtual database may be implemented differently, and may include a variety of optional components, including Map Format Information, Object References, Markers, MetaData, Access Registry, and several application program interfaces (APIs) for Third-Party Data, Release Update, Geocoding Service, Application Provider, Address Point Update Process, and Third-Party Data to Marker Mapping. Each of these components and interfaces are described in further detail below: Not every embodiment will use or require these features.

### Third-party Data API

In accordance with an embodiment, the Virtual Database includes a third-party data API. The third-party data API allows third-party data providers to communicate their data to the Virtual Database environment. More particularly, the third-party data API allows foreign objects to be imported into the Virtual Database. Some amount of information, for example a unique identifier, is needed from each data provider to achieve a suitable cross reference. If the third-party requires the digital map data provider's geocoding services then sufficient address information must also be supplied. If geocoding is not necessary then the objects latitude and longitude (lat/lon) information should be supplied along with the address information. Only those minimal details required to geocode or position the third-party identifiers need be stored in the Virtual Database. The actual details of which object or information is present at the location can continue to be stored externally and controlled by the third-party. In accordance with some embodiments, the system can also utilize a technique of offset pointer addressing described in copending PCT applications titled “ARRANGEMENT FOR AND METHOD OF TWO DIMENSIONAL AND THREE DIMENSIONAL PRECISION LOCATION AND ORIENTATION DETERMINATION”; Application No. PCT2006/000552, filed Nov. 11, 2006; “METHOD AND APPARATUS FOR DETECTION AND POSITION DETERMINATION OF PLANAR OBJECTS IN IMAGES”; Application No. PCT/NL2006/050264, filed Nov. 3, 2006; and “METHOD AND APPARATUS FOR DETECTING OBJECTS FROM TERRESTRIAL BASED MOBILE MAPPING DATA”; Application No. PCT/NL2006/050269, filed Oct. 30, 2006 by Inventor Hans Ulrich Otto, and incorporated herein by reference.

### Third-Party Data Sharing Scenarios

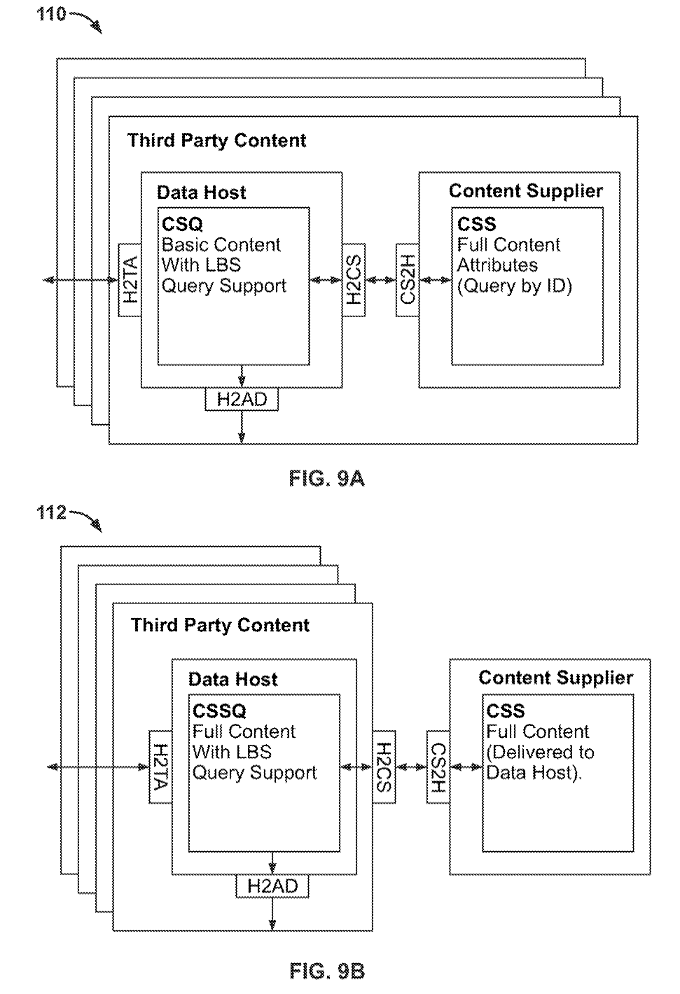

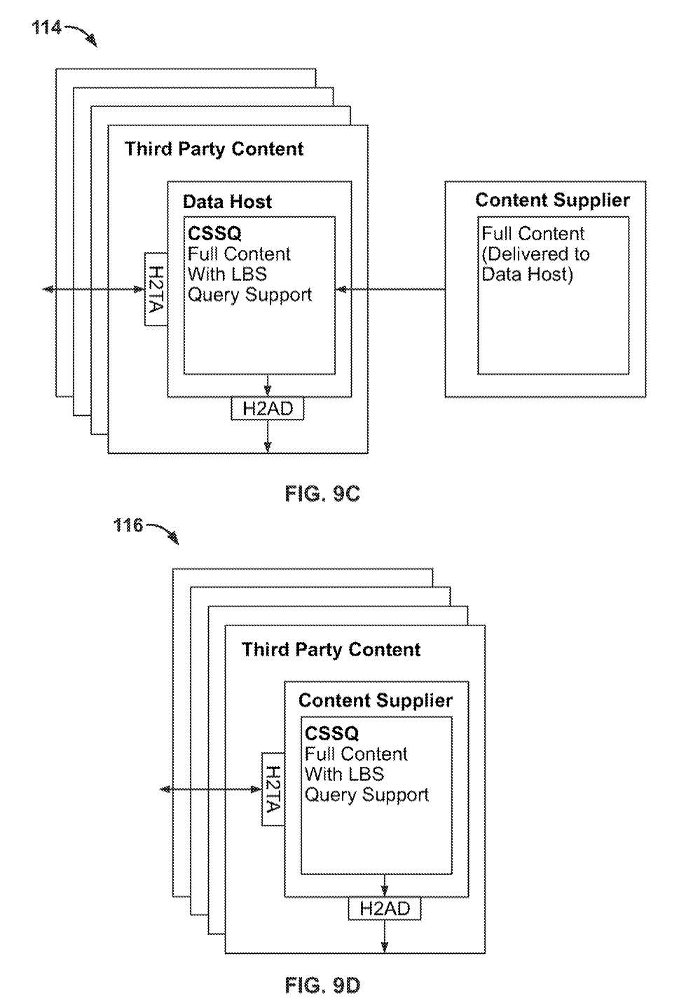

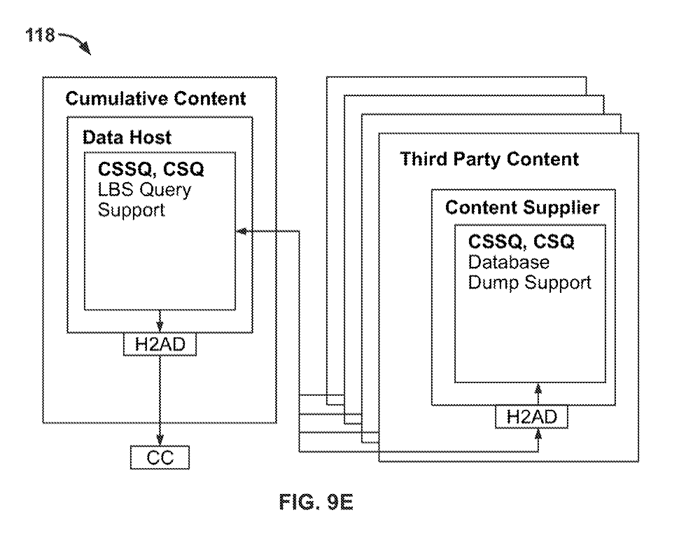

FIG. 9 shows an illustration of how third-party data can be integrated with additional content in the Virtual Database at varying degrees of confidence in accordance with embodiments of the invention. As shown therein, depending on the particular embodiment, the various data sources and databases can comprise:

File-of-reference database (TA DB). This provides georeferencing and address point retrieval and creation services.

Cross-Reference Database (XREF). For content suppliers, the XREF serves two purposes: to describe content to potential application developers; and to maintain links (georeferences) between their objects and the file-of-reference over time.

Content Supplier Query Database (CSQ). This database contains POI Names, types and subtypes, keywords, addresses, marker and address point IDs, addresses, etc.; essentially whatever is needed to complete basic Location-Based Services (LBS) queries, and return enough results that the points could be displayed upon a map. It may be hosted at a specially designated data host, or the content providers' own site.

Content Supplier Source Database (CSS). This database contains the original data a content provider has to offer the VDB, before it was georeferenced. It will have a lot of unique content not available in the CSQ (unless they are merged as the CSSQ; see below) such as telephone numbers, contacts, web-pages, e-mail addresses, faxes, textual descriptions, etc.

Access to databases at different sites can be made through web services using the SOAP or another protocol. For each class of database there can be a standard web service definition, to support a particular usage. This then allows the system to support a number of interfaces, including:

TA2H—(“Tele Atlas to Host”) Service made available by the digital map provider (for example, Tele Atlas) to host of third party content. Allows host to register themselves as a data provider, describe their data source(s), define rules for sharing their content with other VDB participants. Allows host to submit requests for new XREF markers, address points and other location references, by submitting a subset of their own content.

H2TA—(“Host to Tele Atlas”) Service made available by host of third party content to the digital map provider, e.g. Tele Atlas. Allows the map provider to “push” a list of updates (e.g., new or moved address points) to the content provider.

TA2AD—(“Tele Atlas to Application Developer”) Service made available by the map provider to an Application Developer. Allows them to register themselves on the content network and search the metadata about a content supplier that suits their needs. Allows them to pay for a particular content provider's service.

H2AD—(“Host to Application Developer”). Service made available by host of third party content to Application Developers.

If a content supplier has two databases—one supporting LBS queries linked to the base map hosted at a third party's site, the other the original database using the original schema at their own site available by id—they may communicate with the following web services: CS2H—(“Content Supplier to Host”) and H2CS—(“Host to Content Supplier”).

FIG. 9A illustrates an environment that shares basic content using standard CSQ database, detailed content in original database made available by content provider. The content supplier needs to provide simple web service to query objects by IDs and provide updates to CSQ. This is a good solution for highly dynamic data provider not wanting to modify their native database.

FIG. 9B illustrates an environment in which data is made available to application developers via CSSQ database, with extended schema (to include additional content from supplier). Updates are made available by content supplier via a simple web service. This is a good solution for moderately dynamic data with content providers whose native database won't support end-user queries.

FIG. 9C illustrates an environment in which data is made available to application developers via CSSQ database, in extended standard schema (extended to include additional content from supplier). This is an effective solution for data that is not highly dynamic.

FIG. 9D illustrates an environment in which the content supplier hosts their own data, using their own database, in any format as long as they support the web services and are tuned to them. This is a good solution for technologically sophisticated content suppliers who are protective of their dynamic content.

FIG. 9E illustrates an accumulator environment, which makes content from multiple CSQs available from a single web service. Sometimes, for performance reasons, there is value in accumulating the content of multiple providers into a single database. Some application developers do this to guarantee a certain level of service. Content from multiple willing providers can be accumulated into a single CSQ and made available through the H2AD interface, as shown in FIG. 9E. This is particularly useful for accumulating similar content from distributed organizations, such as state governments, where the cumulative CSQ could provide broad coverage.

### Map Format Translation

Many third-party data sources use different and otherwise incompatible map formats. To address this, some form of mapping information can be provided within the Virtual Database (VDB) environment to translate such information as address points, Traffic Message Channel (TMC) location codes, and geocoding services. If a fixed map format is not used, then alternatively pointers, ULROs, and other forms of linking may be used. In accordance with one embodiment, the file-of-reference contains address points and TMC location codes which serve as permanent location references in the digital map. These references are then used to link and reposition the third-party data onto the digital map. For example, if an edge of a particular map object is moved, then the address points related to that edge will move accordingly. This automatic repositioning minimizes the need to re-geocode the third-party data in response to a revision of the file-of-reference.

### Address Points

In accordance with an embodiment, address points can be provided. In a typical file-of-reference or base map, not each location that has an address will have an actual point in the map. For example each of street addresses “1 Battery Street” and “2 Battery Street” may not have their own discrete map points but instead may be included in the more general range “1 to 10 Battery Street”. In accordance with an embodiment, each of these map locations can be given their own discrete address points. The advantage of address points includes ease of use, and greater performance speed in referencing any particular location in the map. The disadvantage is that care must be taken when a large number of map locations are given address points since the corresponding database can become quite large.

### Enhanced Integration Database

In accordance with one embodiment, the Integration Database provides the following additional functions: (1) Registers online third-party data objects in a central location (only the data necessary for registration need be stored centrally, with most of the data remaining at the third party's site);(2) (in some embodiments), provides or creates permanent location markers within the file-of-reference for repositioning purposes; (3) notes changes and discrepancies in information, such as street address information, and reports these changes to the interested parties; (4) stores any relevant metadata about the various third-party data sources, what they contain, and how they can be accessed and displayed; (5) allows application developers to create relationships (including binary relationships, 1-to-many relationships, and many-to-many relationships) between the file-of-reference and the third-party data sources, and between different third-party data sources; and (6) provides automated relationship building services for geospatially related objects. In accordance with one embodiment, the integration database accepts map identifiers, including address points, TMC locations, and other positional information, from the digital map provider, and links this positional information with the third-party data. The mapping can be returned to the third-party data providers for their own purposes. While keeping all of the proprietary third-party data at each data provider's source, application developers can then utilize various APIs to retrieve digital map data from the map provider, and merge it with the third-party data, to create the final product. Since the integration database sit between the file-of-reference and the third-party databases, the system allows third-party data suppliers to update the database according to their own release schedules; allows third-parties to submit requests for location markers (described in further detail below) without those markers automatically becoming part of the file-of-reference; makes ownership and responsibility for data objects unambiguous, since the quality of the data or information in the third-party data source remains the responsibility of those third-parties; avoids cluttering the file-of-reference with anything other than what the digital map provider is themselves responsible for maintaining; and allows development of the various databases and data sources can take place in parallel, and largely independently of one another.

### Object References

In accordance with one embodiment, any existing address points, location codes, and other positional references can be extracted from the pointer, or ULRO information to provide a mechanism for linking the third-party data to a geographic location on the file-of-reference. When the third-party data is geocoded onto the file-of-reference, a matching is performed to locate the corresponding address points. If no address identifier (such as an address point) exists at the geocoded or provided location, then a temporary address identifier or point can be created. This is useful for adding features to an address which may not have existed in the file-of-reference to begin with, e.g. a particular building address such as “220 Battery Street”.

### Markers

In accordance with one embodiment, a variety of markers are provided in the integration database. Markers are records that refer to a single entity in one of the various databases or data sources participating in the Virtual Database environment. The marker makes it easier to keep track of changes in the digital file-of-reference and the third party databases, making periodic re-integration more reliable and efficient. In accordance with one embodiment various types of markers can be used, including Location Markers, Object Markers, and Relationship Markers.

### MetaData

In accordance with one embodiment, metadata information can be stored together with the address points and markers. The metadata stores information about the external third-party data sources, and assists in the seamless data integration of the Virtual Database with application providers and data resellers. The metadata may include information such as data source, connection information, content/schema, coverage area, and data quality, object type and class, and data-specific relationship information, such as a restaurant location and the parking lots which are closest to that location. Not all embodiments of the virtual database environment utilize metadata.

### Access Registry

Data providers may require adequate protection of their data to ensure their data's continued commercial value. In accordance with one embodiment, an access registry is provided to maintain this level of security, through the creation of constraints in which customers or third-parties may view their data, and in what relationships may be allowed to exist between their data and other third-party data providers.

### Release Update API

In accordance with one embodiment a release update API is provided to allow the file-of-reference to be easily updated with new release cycles (using either a “push” process to push the data update to the file-of-reference, or a “pull” process which allows the virtual database system to pull updated data into the file-of-reference). Using a Release Update API, the file-of-reference may be updated through a complete re-release of the map, or through an incremental release process.

### Geocoding Service API

In accordance with one embodiment, a geocoding service is provided to perform address cleanup/normalization, and to geocode the addresses onto the provider's digital map in some automated and/or semi-automated means.

### Application Provider API

In accordance with one embodiment, an application provider API is provided to allow a third-party application developer to access the Virtual Database, and to have a seamless view of the provider's map (the file-of-reference) integrated together with all of the third-party data.

### Address Point Update Process API

In accordance with one embodiment an address point update process API is included to allow requests from third-parties for additional address points to be added into the file-of-reference.

### Third-party Data to Marker Mapping API

In accordance with one embodiment, a third-party Data to Marker Mapping API is provided to allow third-party data providers to obtain the markers and/or geocoding results that their data has been mapped to.

### ULRO-Based Virtual Database Environment

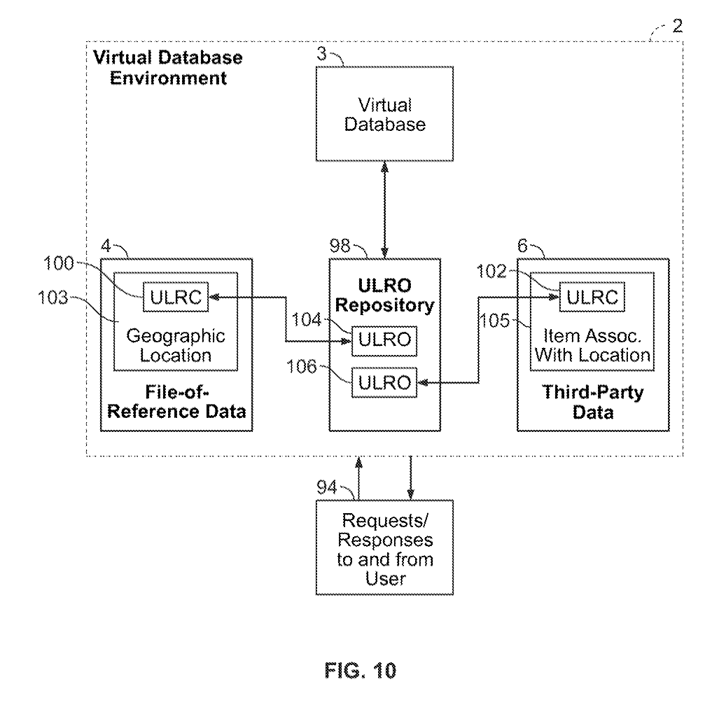

As described above, in accordance with an embodiment, the system can utilize permanent markers referred to as Universal Location Reference Objects (ULROs) for map features. FIG. 10 shows an illustration of a Virtual Database environment or system in accordance with another embodiment of the invention. In accordance with this embodiment, the virtual database environment uses ULROs. As shown in FIG. 10, the virtual database environment 2 comprises a file-of-reference data 4 and third-party data 6, which together are linked to form the virtual database 3. In accordance with this embodiment, the file-of-reference and the third-party files include ULRCs 100, 102, associated with each geographic location 103, or data item associated with a geographic location 105 respectively. As described in further detail in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference, a ULRO comprises a permanent identification code designed to identify a selected location. In turn, a location may be associated with one or more geographic items. ULROs can be employed to establish traversable links or connections between the file-of-reference and the third-party files. In accordance with one embodiment, ULROs 104, 106 are stored in a ULRO repository 98, which may or may not be part of the file-of-reference data. A ULRO comprises eight principal components, some or all of which may be utilized depending on the particular implementation: 1) a set of name information; 2) a super-set of coordinates; 3) a universal location referencing code (ULRC) uniquely corresponding to the location; 4) a file-of-reference pointer field comprising a file-of-reference pointer; 5) a third-party-file pointer field comprising one or more third-party-file pointers; 6) a file-of-reference back-pointer field comprising a file-of-reference back-pointer; 7) a third-party-file back-pointer field comprising one or more third-party-file back-pointers; and 8) a metadata field.

### Digital Map Provider and Third-Party Roles

As described above, a basic principle behind the VDB approach is to enable a digital map provider to provide its customers with highly reliable links between its digital maps and the data belonging to a plurality of third-party data providers. A useful side-effect of the linking process is that it provides feedback for improving the quality of data belonging to both the digital map data provider and its third-party partners. Once a link between the third-party data and the file-of-reference is created, it can be maintained indefinitely. The apparent permanence of these links makes it easier to integrate third-party data between subsequent data releases.

### Identification of Third-Party Data

Third-party data objects contain the information needed to derive relationships between that third-party data and the digital map provider data, or between two or more third-party data sources. While much of the content of these objects can be treated in a generalized way, whichever entity hosts the Virtual Database should be familiar with the information specifically needed to create and maintain the relationship. The most important category of relationships are between instances of third-party data objects and instances of map features, referred to herein as “links”. Links can be used to locate third-party map features relative to transportation elements; to tie third-party data to segments of transportation elements; to tie third-party data to map features in their entirety; and to describe relationships between map features.

### Identification of Content of Third-Party Data Used to Link

In accordance with one embodiment, the third-party data source must provide enough information to enable a VDB administrator to create the necessary links to their data. This information is then coded into a database table in one form or another. Some of the types of information that may be provided includes: (1) Links used to locate third-party data objects relative to the file-of-reference transportation network; (2) Links referring to segments of the transportation network, and which specify a segment of a transportation element to be linked to dynamic third-party attributes or other descriptive information; (3) Links tying third-party data objects to map features. This is different from the previous category because it is a reference to an entire feature, not a piece of it; and (4) Links between map features. This allows the VDB administrator to integrate relationships between map features from third-party data sources.

### VDB Third-Party Linking Processes

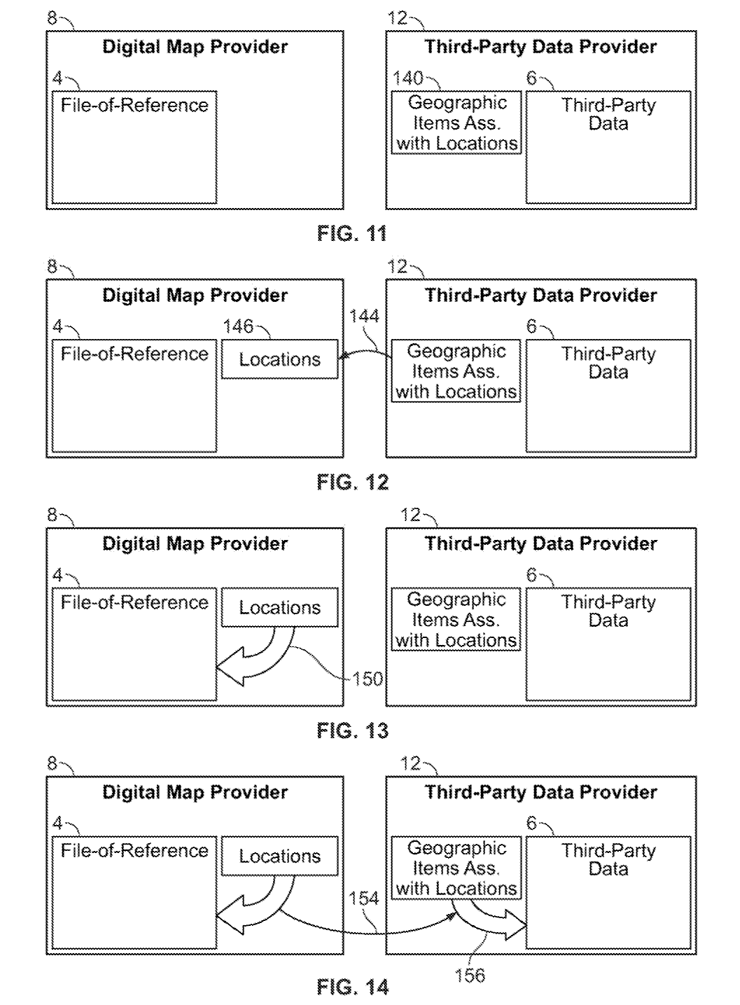

As described above, in accordance with an embodiment, the information in the file-of-reference and the third-party data can be linked in real-time to form the virtual database. FIGS. 11-18 show the various steps in the method of creating and using a Virtual Database in accordance with an embodiment of the invention. In particular, FIG. 11 permanent identifiers are first assigned to the features in the digital map data provider's file-of-reference.

In FIG. 12, location information (such as addresses, or coordinates) is copied or transmitted from the third party's database or data source into a temporary table in, or associated with, the file-of-reference, together with any third-party object descriptors, Ids, or link type, where applicable.

In FIG. 13, the system creates links to the file-of-reference using a combination of automated tools (geocoding, database queries), and when necessary manual intervention.

In FIG. 14, the links that were created in the previous step are delivered or communicated to the third-party. At this point, third-party software products, or user interfaces can be built to make use of the links in a variety of different ways, such as providing a virtual map to the end user.

The above steps can take place dynamically, i.e. in real-time upon a request from a user or from another system to access a virtual map or map information. In some embodiments, the digital map provider can create the virtual map itself. Since links can be delivered to the third-party, this allows the third-party to also create the virtual map. As described above, the creation of the virtual map can be a piecemeal process, with some preliminary information returned in response to an initial request, and subsequent information returned in response to more detailed requests.

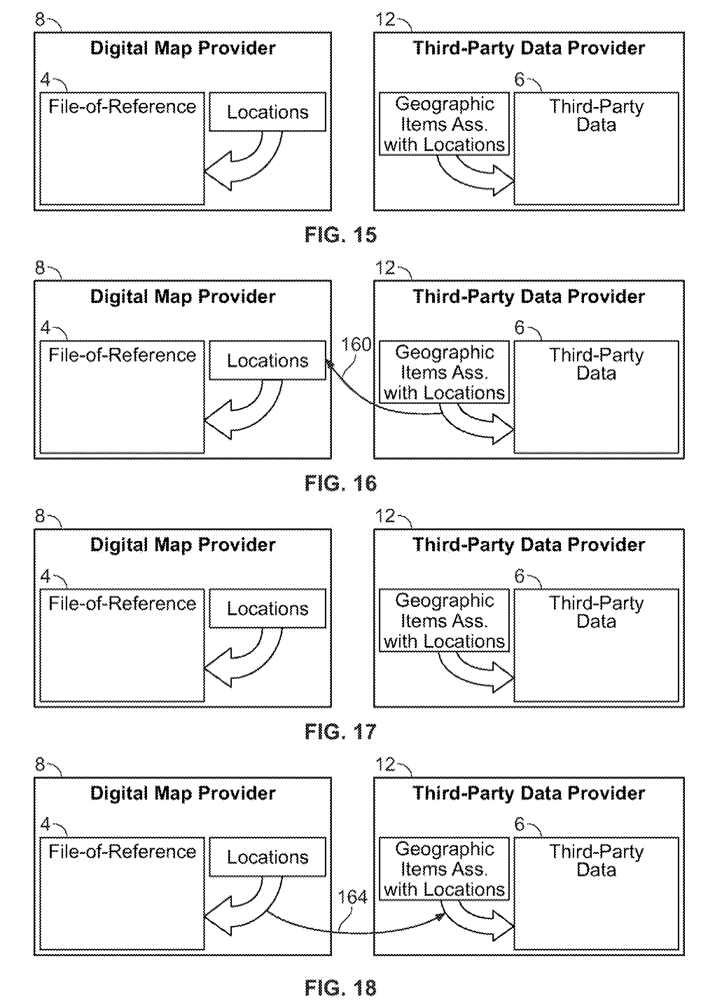

In FIG. 15, the system is now in a steady state that allows for maintenance by the parties of their respective sets of data. The digital map data provider is responsible for noting changes in the links due to any modification, deletion, and creation of map features in their own set of data, i.e. the file-of-reference. The third-party is similarly responsible for noting changes in links due to data object deletion or repositioning within their set of data (i.e. the third-party data file).

In FIG. 16, the system allows for resynchronization, for example, if information has changed in the third-party file and the third-party delivers an updated list of locations and broken links to the digital map data provider.

In FIG. 17, the system allows for repair. Unneeded links are removed from the file-of-reference. New links, and those broken due to some change in either of the databases, are regenerated.

In FIG. 18, the system redelivers any updated links and other information to the third-party. This ensures that the map data from the multiple data sources will be consistent when the virtual database is populated in response to a user request. Again, at this point, software products, user interfaces, or functional API's, can be built that make use of the new links. In particular, since the third-party also receives the updated information, the third-party benefits in being able to use this updated information in their own software products

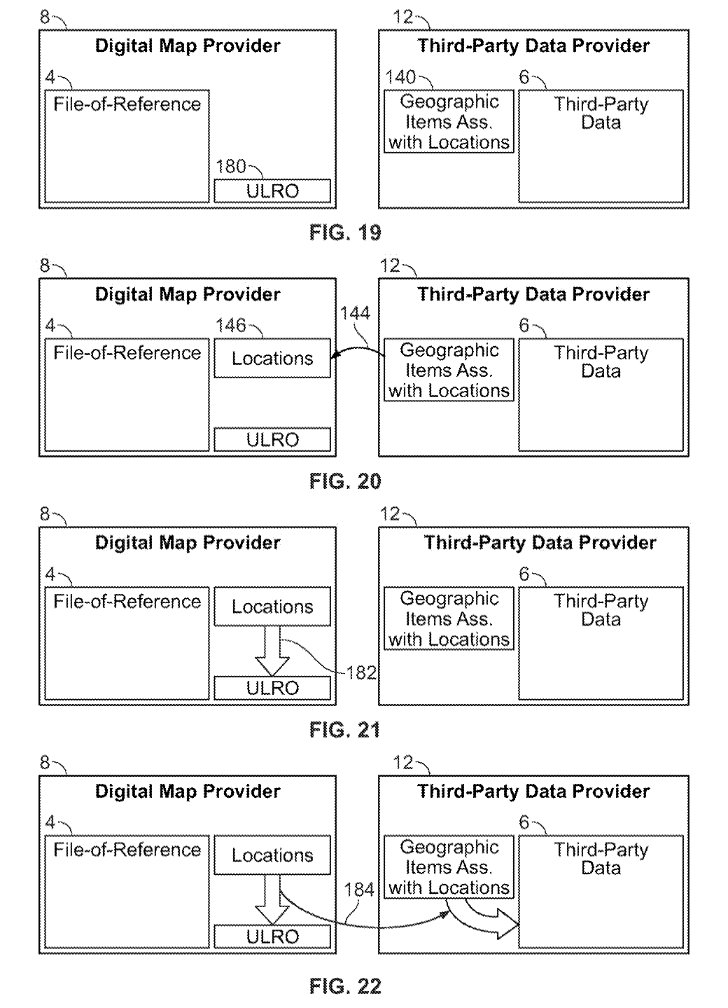

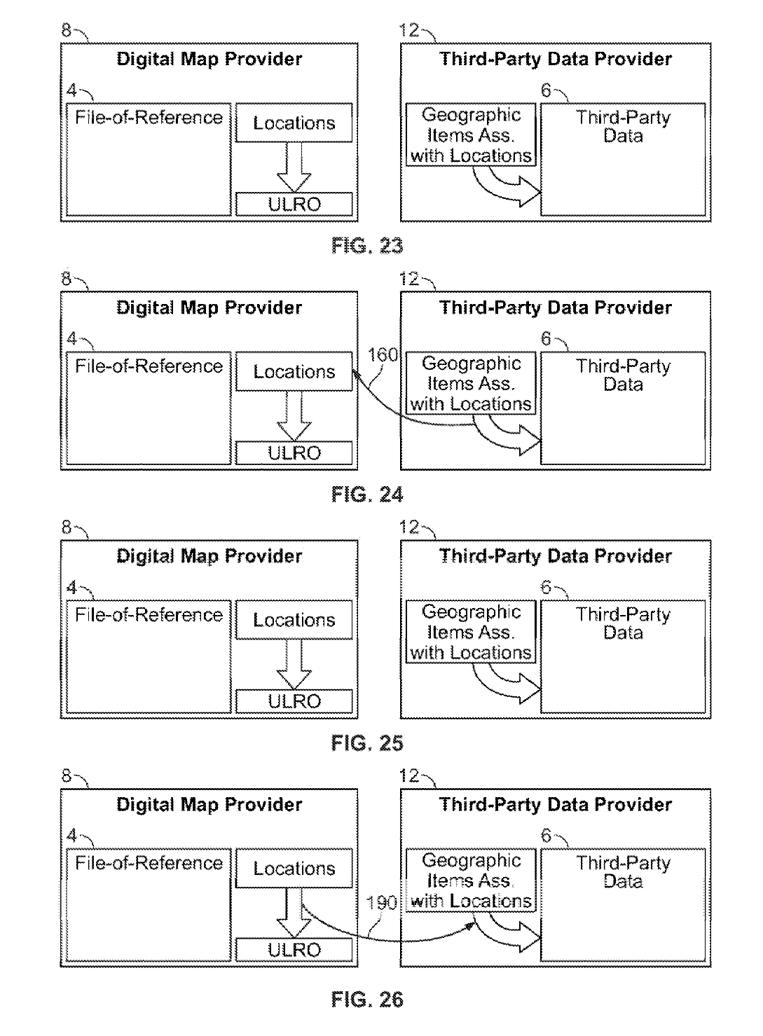

FIGS. 19-26 show the various steps in the method of creating and using a Virtual Database in accordance with another embodiment of the invention in which ULROs are used. FIGS. 19-26 largely duplicate the operations in FIGS. 11-18 respectively. The difference here is that instead of a standard map format, pointer mapping, or some other form of mapping, ULROs are instead used to form a basis for creating links. In addition, the ULROs are stored in a ULRO repository, which in FIGS. 19-26 are shown together with the digital map provider, but can be located anywhere in the system, including independently of the map provider or the third-parties. The ULRO repository maintains the links within the ULROs, updating them automatically as necessary. In most other respects the steps are the same, namely FIG. 19 shows that the system assigns and maintains permanent identifiers to the features in the digital map data provider map (the file-of-reference), this time in the form of ULROs. In FIG. 20, the system copies location information (such as addresses, or coordinates) from the third party's database into corresponding ULRO fields in the ULROs, together with third-party object descriptors, IDs and link type, where applicable. In FIG. 21, the system creates links to the file-of-reference using a combination of automated tools (geocoding, database queries) and when necessary manual intervention. This time ULROs are assigned where necessary to third-party map objects, giving them similar identifiers (which in a ULRO implementation can be a ULRC) as identical objects in the file-of-reference. The ULRO is described in further detail in copending U.S. patent application “A METHOD AND SYSTEM FOR CREATING UNIVERSAL LOCATION REFERENCING OBJECTS”; Inventor: Gil Fuchs; application Ser. No. 11/271,436; Filed: Nov. 10, 2005, and incorporated herein by reference. In FIG. 22, the links that were created in the previous step, or copied to ULRO pointerfields, are delivered to the third-party. At this point, software products, or user interfaces, can be built making use of the links in a variety of different ways. As with the embodiments described above, the above steps can also take place dynamically, i.e. in real-time upon a request from a user or from another system to access a virtual map or map information. In some embodiments, the digital map provider can create the virtual map itself, or, since links can be delivered to the third-party, the third-party can also create the virtual map. In FIG. 23, the system allows for maintenance of the different data sets, by the party responsible for that particular data set. The digital map data provider is responsible for noting changes in the links due to any modification, deletion, and creation of map features. The third-party is responsible for noting changes in links due to data object deletion or repositioning within their (third-party) data. Simple changes within the third-party data, such as modifying the attributes of a feature within the map, may not require any changes to the link itself, since when the virtual database is generated the same link will be used to traverse to the new attributes. In FIG. 24, the system allows for resynchronization, wherein the third-party delivers an updated list of locations and broken links to the digital map data provider. In FIG. 25, the system allows for repair, wherein unneeded links are removed from the file-of-reference. In FIG. 26, the system redelivers updated links to the third-party. However, since the ULRO is a dynamic feature, and can exist independently of the map provider or the third-parties; and furthermore since the ULRO repository maintains the links within the ULROs, updating them automatically as necessary, in accordance with most embodiments the latter steps shown in FIGS. 24-26 are not necessary. Finally, as also described above, since the third-party also receives the updated information, the third-party benefits in being able to use this updated information in their own software products. At this point, software products, or user interfaces, can be built making use of the new links.

In all of the examples illustrated above, the link update process is shown flowing between a file-of-reference and a single third-party file. However, it will be evident that in other embodiments, the link updating may flow in a reverse direction, namely beginning with an update at the third-party file and updating the file-of-reference. In addition, while the examples illustrated above show the link update process between a file-of-reference and a single third-party file, it will be evident that the link updating may be between a file-of-reference and many third-party files, or between one third-party file and another third-party file. As discussed above, these titles are intended as descriptive labels more than anything else, since in other embodiments any of the data files or data sources can act as a third-party file, treating the other data file as the file-of-reference.

### VDB Usage Examples

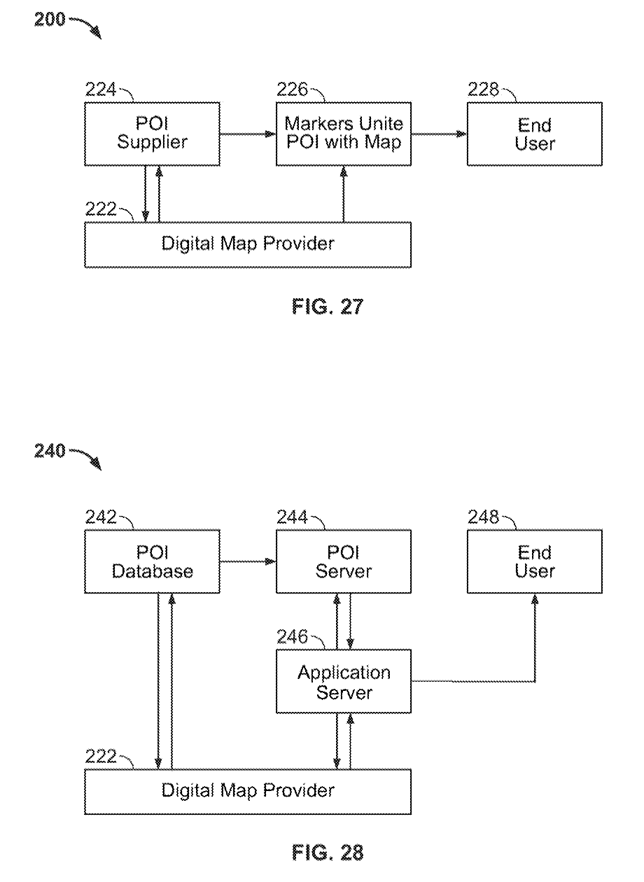

FIGS. 27-28 show illustrations of one embodiment of the VDB system as it may be used in a real-life situation to provide map information to an end user. As shown in FIG. 27, the map provider (for example, Tele Atlas) provides the file-of-reference, or an equivalent set of digital map data. The third-party data supplier, of which only one is shown here, provides information about a set of points of interest (POIs). The term “point of interest” as used herein can also be used to refer to lines, areas, complex, and other map features, not necessarily just points. New POIs can be communicated to the map provider and eventually incorporated in the file-of-reference. In response to a request from an end user, the information from the map provider (the file-of-reference) is integrated with the information from the third-party, and is delivered to the end user via an application vendor's application.

As shown in FIG. 28 The Virtual Database environment allows a file-of-reference map to be updated independently from the third-party points of interest (POIs). The third-party data provider updates their database according to their own needs, and obtains markers from the map provider for each new or updated POI. A POI server takes care of communicating the POI updates to an application server, which in this instances acts both as the integration server and as the delivery vehicle to the end user. In response to a user request the application server provides the appropriately updated and integrated information. Depending on the particular embodiment, the update can be either pushed, or pulled 474, to or from the end user. Using this update technique, POIs and associated content can be intelligently searched and examined before being selected in response to a particular user request. Third-party applications can be shipped with media containing the latest POI data available from the POI source at the time the application is created.

The foregoing description of the present invention has been provided for the purposes of illustration and description. It is not intended to be exhaustive or to limit the invention to the precise forms disclosed. Many modifications and variations will be apparent to the practitioner skilled in the art.

The present invention may be conveniently implemented using a conventional general purpose or a specialized digital computer or microprocessor programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to capturing and annotating media streams, producing a timeline of significant note-taking events, linking still frames to points in or segments of a media stream, recognize any slide changes, production and distribution of meta data describing at least a part of a media stream, and communication of results according to the processes of the present invention.

The foregoing description of the present invention has been provided for the purposes of illustration and description. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing digital map data in a virtual database format, comprising:
an electronic map data covering a map area and that includes location codes for features within the map;
an interface that allows third-party data to be received into the system, wherein said third-party data defines additional feature information for some or all of the features geographically located within the map area;
an integration database that links location codes in the electronic map data with corresponding feature information in the third-party data, and provides the linked information as a virtual database.

2. The system of claim 1 wherein the virtual database is also an electronic map data and is used to generate a map display, including within the map display the feature information provided by the third-party data.

3. The system of claim 1 wherein the location references are a universal location reference that are uniquely assigned to each particular map location.

4. The system of claim 1 wherein the third-party data may be maintained independently by third-parties, and combined with the electronic map data at runtime or upon request to create the virtual database.

5. The system of claim 1 wherein the system comprises the third-party data.

6. The system of claim 1 wherein the system receives the third-party data from an external third-party source via a network or other connection.

7. The system of claim 6 wherein the network or other connection is the Internet.

8. The system of claim 1 wherein the system simultaneously receives information from multiple third-parties.

9. The system of claim 1 wherein the virtual database is created dynamically by the system upon receiving real-time data from the third party, or upon a request from a user.

10. The system of claim 1 wherein the virtual database is updated automatically by updates to a portion or all of either the electronic map data or to the third-party data, independently of the other sources of data.

11. A method for providing digital map data in a virtual database format, comprising the steps of:
providing an electronic map data covering a map area and that includes location codes for features within the map;
receiving third-party data, wherein said third-party data defines additional feature information for some or all of the features geographically located within the map area; and
using an integration database that links location codes in the electronic map data with corresponding feature information in the third-party data, to present the linked information as a virtual database.

12. The method of claim 11 wherein the virtual database is also an electronic map data and is used to generate a map display, including within the map display the feature information provided by the third-party data.

13. The method of claim 11 wherein the location references are a universal location reference that are uniquely assigned to each particular map location.

14. The method of claim 11 wherein the third-party data may be maintained independently by third-parties, and combined with the electronic map data at runtime or upon request to create the virtual database.

15. The method of claim 11 wherein the system comprises the third-party data.

16. The method of claim 11 wherein the system receives the third-party data from an external third-party source via a network or other connection.

17. The method of claim 16 wherein the network or other connection is the Internet.

18. The method of claim 11 wherein the system simultaneously receives information from multiple third-parties.

19. The method of claim 11 wherein the virtual database is created dynamically by the system upon receiving real-time data from the third party, or upon a request from a user.

20. The method of claim 11 wherein the virtual database is updated automatically by updates to a portion or all of either the electronic map data or to the third-party data, independently of the other sources of data.

21. A computer readable medium including instructions stored thereon which when executed cause the computer to perform the steps of:
providing an electronic map data covering a map area and that includes location codes for features within the map;
receiving third-party data, wherein said third-party data defines additional feature information for some or all of the features geographically located within the map area; and
using an integration database that links location codes in the electronic map data with corresponding feature information in the third-party data, to present the linked information as a virtual database.

22. A system for providing digital map data in a virtual database format, comprising:
a reference database that includes data covering a map area and that includes location codes for objects within the map;
one or more third party databases that attribute data for objects that can appear in the map;
a virtual database which provides data to an end user that includes linked information from the reference database and the one or more third party databases, such that the user can query the virtual database to determine information and relationships amongst the objects in the reference database and the objects in the one or more third party databases.
